(19) United States
(12) Patent Application Publication
(10) Pub. No.: US 2012/0145641 A1
(43) Pub. Date: Jun. 14, 2012

(54) Method and Apparatus for removing senescent cells

(76) Inventors: Justin Rebo, Menlo Park, CA (US); Ben Zealley, Cambridge (GB); John Schloendorn, Menlo Park, CA (US); Mark Hamalainen, Redwood City, CA (US); Keith Causey, Redwood City, CA (US)

(21) Appl. No.: 13/217,244

(22) Filed: Aug. 25, 2011

Related U.S. Application Data
(60) Provisional application No. 61/378,810, filed on Aug. 31, 2010.

(51) Int. Cl. B03C 1/02

(52) U.S. Cl. 210/695

(57) ABSTRACT

A major type of unwanted cells that accumulate in aging are anergic cytotoxic T-cells. These cells often have virus-specific T-cell receptors, as well as other surface markers that distinguish them from their youthful counterparts, and are thought to play a major role in the decline of the immune system with age. Here we disclose the use of magnetic cell separation methods and apparatuses to remove senescent T-cells defined by the surface markers CD8+, KLRG1+ and CD8+, CD28−. We disclose how these markers are used to remove anergic T-cells from the blood of aged C57BL/6 mice, resulting in lasting rejuvenation of their immunological marker profile. Using antibodies with magnetic microparticles linked to their Fc domains, we first developed a method to use magnets to filter out the unwanted cells from the blood, and later constructed a device that does this automatically.

### RELATED APPLICATION

This full application corresponds to provisional application #61/378,810, METHOD AND APPARATUS FOR REMOVING SENESCENT CELLS, filed Aug. 31, 2010.

### STATEMENT REGARDING FEDERAL FUNDING

This work was not federally funded.

### JOINT RESEARCH AGREEMENT

This application was filed by the inventors on their own behalf.

### BACKGROUND

One of the major types of aging damage is thought to be the accumulation of unnecessary and potentially harmful cells, many of which are both non-proliferating and disinclined to die (de Grey, Sci Aging Knowledge Environ 2003, VP1 (2003); Campisi, Mech Ageing Dev 126, 51-58 (2005)). Means to eliminate such cells are likely to be an essential part of any comprehensive rejuvenation therapy. An archetypal example of such cells are the anergic cytotoxic T-cells of the aging immune system (Pawelec and Gouttefangeas, Aging Clin Exp Res 18, 171-173 (2006)).

Anergic T-cells are one of the major types of unwanted cells. They accumulate in response to chronic infection, mainly by CMV, and contribute to immunosenescence. These cells usually have virus specific T-cell receptors, as well as other surface markers that distinguish them from their youthful counterparts. Just which surface marker is best to discriminate against all other cells is not entirely clear. Dramatic differences exist between species. The optimal answer for mice might look quite different from the optimal answer for humans.

Here we consider three surface markers to distinguish anergic T-cells in humans and mice: KLRG1, CD57 and CD28.

### A. KLRG1

Anergic murine T-cells, like their human counterparts, can gain killer-cell-like markers. One such marker, KLRG1 (Killer cell lectin-like receptor G1), has recently been characterized as a marker of both murine and human anergic T-cells. The function of the KLRG1 protein is not well understood, but it is generally thought to play a complex role as a communications node related to immunosuppressive signaling (Tessmer, et al., Int Immunol 19, 391-400 (2007)).

Chronic viral infection can induce “senescent” CD8+/KLRG1+ T-cells in mice and humans (Voehringer, et al. Blood 100, 3698-3702 (2002)), possibly as a mechanism to prevent viral clearance by the T-cells. CD8+/KLRG1+ cells are persistent for at least six months when transferred into recipient mice. Thus, these inactive cells may persistently occupy “immunological space”, inhibiting the differentiation of functional memory and naïve T-cells. Humans too accumulate virus-specific CD8+/KLRG1+ cells during aging, a phenomenon implicated in the decline of the aged immune system (Voehringer, et al., J Immunol 167, 4838-4843 (2001)). In vitro, isolated human CD8+/KLRG1+ cells fail to proliferate in response to antigenic stimulation, whereas CD8+/KLRG1− cells do proliferate (ibid.).

These results are consistent with the idea that CD8+/KLRG1− cells may legitimately be called “senescent”, as they constitute a persistent, non-proliferative, apparently dysfunctional population, which arises in an aging-dependent manner as a side-effect of extensive T-cell proliferation. A means to eliminate these cells is believed to be of benefit in basic research as well as to medicine.

### B. CD28

CD28 is the receptor for the stimulus provided by antigen-presenting cells to prime cytotoxic T-cells against a target antigen (via CD28 ligands CD80 and CD86). T-cells that have not experienced this interaction will not proliferate or unleash cytotoxicity against their target. Thus, it seemed rather suspicious when it was first discovered that CD28⁻ T-cells accumulate in human aging (Effros, et al., Exp Gerontol 29, 601-609 (1994)).

CD8⁺28⁻ cells do not proliferate as well, and have shorter telomeres than CD8⁺28⁺ cells in vitro and in vivo (Monteiro, et al., J Immunol 156, 3587-3590 (1996)). The extent of CD28 extinction on CD8⁺ cells predicts impairment of influenza vaccine response in the elderly, as well as frailty and mortality (Saurwein-Teissl, et al. J. Immunol. 168 (11):5893-9 (2002); Semba, et al., Exp Gerontol 40, 81-87 (2005); Wikby, et al. J Gerontol A Biol Sci Med Sci 60, 556-565 (2005)). Thus, these cells can be characterized as bona fide senescent (i.e. non-proliferative, death resistant and malfunctioning) T-cells (Vallejo, Immunol Rev 205:158-169 (2005)).

Another key feature of CD8⁺28⁻ cells is that most of them bear T-cell receptors specific for common persistent viruses, such as cytomegalovirus and Epstein-Barr virus (Looney, et al. Clin Immunol 90, 213-219 (1999)). Since this discovery, evidence has been accumulating that the viruses may be causing T-cell senescence (Pawelec, and Gouttefangeas, Aging Clin Exp Res 18, 171-173 (2006)).

It appears that large accumulations of CD8⁺28⁻ cells in aging occupy space, and thus reduce the numbers of functional cells not only the CD8 compartment, but also the CD4 compartment (Pourgheysari, et al., J Virol 81, 77759-7765 (2007)). This manifests as reduced antibody responses in patients with high CD8/CD4 cell ratios, and high CD8⁺28⁻ counts in particular (Wikby, et al. J Gerontol A Biol Sci Med Sci 60, 556-565 (2005)). The CD4 compartment itself shows CD28 extinction too, but this is somewhat less dramatic than in the CD8 compartment. CD4⁺28⁻ cells too have mostly virus-specific T-cell receptors (Pourgheysari, et al., J Virol 81, 77759-7765 (2007)) and similar properties as CD8⁺28⁻.

CD28 extinction is a primate-specific phenomenon—it is not seen in standard laboratory mice (Vallejo, Immunol Rev 205:158-169 (2005) and Ortiz-Suárez, and Miller, Clin Immunol 104, 282-292 (2002)). Instead, mouse CD28⁺ cells become resistant to ligand-mediated stimulation in aging, for poorly understood reasons (Engwerda, et al., J Immunol 152, 3740-3747 (1994)).

Additional difficulties with targeting CD28⁻ T-cells in humans arise from the fact that the absence of something cannot be easily recognized by most interventions. This is because it is absent from most healthy cells in the body, and so the therapy would have to encode an “AND” operator, such as “destroy only CD28⁻ AND CD8⁺ cells”. Current therapeutic approaches based on affinity recognition of surface markers (antibodies, targeted nanostructures, Adnexins, ect.) cannot deliver this, because no solution exists for getting the affinity reagents to two different things to communicate and function as a logical “AND” gate in the patient. As we will discuss below, our scrubbing proposal (being all ex vivo) provides an elegant solution to create the missing AND gate.

### C. CD57

CD57 (human natural killer-1) is a cell adhesion molecule bearing a sulfoglucuronyl moiety. Recent evidence implicates CD57 as a marker of CD8+ T-cell replicative senescence. Similar to KLRG1, CD57 might be used as a positive marker for removing senescent CD8+ CD57+ T-lymphocytes (Brenchley, Blood 2003; 101 (7): 2711-20).

### DESCRIPTION OF THE DRAWINGS

FIG. 1—Reduced senescent CD8 cells as a percentage of total CD8 cells by a factor of 7.3, with a reduction significant to a p value of 0.0066 (figure an average of 7 animals). Also reduced normal KLRG1+ NK cells by a similar factor (data not shown).

FIG. 2-4—different layouts for apparatuses to remove senescent t-lymphocytes.

### DETAILED DESCRIPTION

There are two main routes to access lymphocytes, via the blood or lymph. At any one time it is inadvisable to remove more than 10% (˜0.14 ml) of a mouse's blood from it's body. However, initial experiments to purify CD8+ cells and separate CD28− or KLRG1+ cells, a simple tail snip to obtain up to 0.14 ml of blood per animal would be sufficient. Alternatively, if more blood is required, the animal may be sacrificed.

Where the blood/lymph is returned to the animal, the optimal route for removing ATCs is probably via the lymphatic system. The recommended limit of blood removal from a mouse is 25% (or 6.4 ml) over 28 days and only 1/10- 1/100 of lymphocytes are circulating in the blood at any given time. Accessing the lymphatic system of a rodent model is a relatively simple procedure, involving direct cannulation of the thoracic duct, and can be performed in mice and rats.

Surgical access to the lymphatic system of humans can be achieved at the thoracic duct, a relatively large vessel through which the majority of lymph passes. An extracorporeal circuit can be and is commonly established there. Remarkably, such circuits can remain active for at least hundreds of days despite minimal efforts to ensure biocompatibility (Sato, et al., Int J Artif Organs. 14 (12):800-4 (1991)). This may be due to the presence of high levels of immune mediators preventing infection.

In aged mice, DNA vaccination is less protective, and this is in part due to a decreased cytotoxic T-cell response (Klinman, et al., J Gerontol A Biol Sci Med Sci 53, B281-B286 (1998)). In the case of successful and sustained T-cell count rejuvenation, we could obtain the gene encoding the DNA vaccine by chemical gene synthesis, and imitate this experiment to test if the cytotoxic T-cell response to it can be rescued, and if this improves survival in vaccinated and non-vaccinated animals.

TABLE 1
Age in months of C57BL/6 mice when the fraction
surviving reaches a given value

| Surviving Fraction | 90% | 75% | 50% | 25% | 10% |
|---|---|---|---|---|---|
| Males | 19 | 24 | 27 | 30 | 32 |
| Females | 18 | 22 | 25 | 28 | 30 |

The basic concept of magnetic cell sorting is to selectively tag cells with super-paramagnetic particles, and then separate them by applying a magnetic field and washing away the untagged cells. The technology was pioneered in the mid 1980s as an alternative to gradient centrifugation for separation of lymphocyte subsets. By coating the magnetic nanoparticles with antibodies for the target cell type, purities of >99% can be obtained.

Super-paramagnetic iron oxide nanoparticles (SPIONs) are the most common type of magnetic particle. They are generally considered to have a low and dose-dependent toxicity. However, the toxicity can be eliminated by coating them in poly-(ethylene glycol) (PEG), in which case they are biocompatible at concentrations as high as 1 mg/ml.

Importantly for our desired application, cells can be isolated by magnetic cell sorting without any discernable loss of function or damage (Zahler, et al., J Immunol Methods. 200 (1-2):173-9 (1997)). The size of the particles is important for sorting, as large particles of >0.1 μm can physically disrupt cells and are difficult to remove due to their larger surface area (and consequently large number of antibodies per particle).

The beauty of magnetic cell sorting is in the simplicity and efficiency of the method. Cells are mixed with the magnetic antibodies, a magnetic field is applied, and the unbound cells are washed away. The procedure can be carried out with a test tube and permanent magnet.

Although our method would result in few if any magnetic particles entering the body, it is notable that they are already being used in humans for medical and research purposes. Magnetic nanoparticles have innumerable potential medical applications, and are at the center of much research activity.

Accumulation of anergic T-lymphocytes is a major type of damage accumulating with aging. Developing a completely non-invasive method for specific elimination of a cell type is a major challenge. It requires delivery into circulation of an agent(s) that can specifically recognize the target cell type and direct it to commit apoptosis (ideally) or necrosis (less desirable). Our method simplifies the problem by selecting and eliminating these cells outside of the body. In this way, precise instruments and quality control can be brought to bear, and there is no danger of side effects due to an internally delivered agent.

The method provides a selective technique to extract anergic T-cells (ATCs) while leaving other lymphocytes virtually undisturbed. The method, termed “Scrubbing” (by analogy to the scrubbing of smoke from power plants), involves labeling and depleting ATCs ex vivo using antibodies for ATC specific markers.

The goal of our scrubbing methods will be the selective therapeutic removal of the cell population bearing CD8⁺, KLRG1⁺ in mice. To keep things lean, and only obtain proof of concept for the technology, we choose this limited marker at the best compromise of a definition of anergic T-cells. Other suitable markers may be CD8+, CD28− or CD8+, CD57+

The preferred antigen combination is CD8+, KLRG1+, which is thought to most specifically define senescent T-lymphocytes in mice and CD8+, CD28− in humans. For the purpose of the example below, we used only KLRG1+, which would also mark circulating natural killer cells (NK). Removing NK is a side-effect ideally to be avoided in clinical use, but was considered acceptable for the purpose of the example below. In the preferred mode, oe would use a second magnetic antibody against CD8, discard the resultant CD8⁺ KLRG1⁺ fraction, and put all other cells back into the animal.

### EXAMPLES

### Example 1

### Preclinical Use

C57BL/6 mice were obtained with preinstalled jugular venous catheters from Taconic, Inc. Biotinylated antibodies were obtained from eBioscience Inc. Paramagnetic nanoparticles coated in streptavidin were obtained from Bioclone, Inc.

Magnetic particles coated in streptavidin were bound to our biotinylated anti-KLRG1 antibodies (2F1 monoclonal antibody, eBioscience, catalog no. 13-5893-81) using the protocol from the magnetic particle manufacturer. The resultant magnetic antibodies were washed in sterile phosphate buffered saline 3 times by using a large rare earth magnet to pellet them at the bottom of a 1 ml centrifuge tube. The supernatant was discarded. 100 ml of this solution was then added to the sequestration chamber of the device we constructed.

The machine that was designed to perform the magnetic sorting operation had three robotic subunits (these, with the exception of the syringe pump and laptop, we built in the research facility) and a coordinating computer (a stock laptop) at its core. The subunits consisted of the syringe pump, the inversion stirrer and the magnet positioner. The consumable feature these three subunits manipulated was a custom-built piece of tubing having at its terminal ends a blunt needle for damage-free insertion into the mouse's jugular catheter and a luer-lock fitting that enabled attachment to the syringe pump. Situated between these two terminal ends was an enlargement in the tube, used as a sequestration/mixing chamber. It was also where the magnetic antibodies were stored. It served the triple role of container for the magnetic antibodies, mixing of the blood with the magnetic antibodies and holding the captured cells there after mixing. This “blunt needle/sequestration chamber/leur-lock” featured construction, hereafter referred to as a harness, was consumable because each mouse required a separate unit.

Prior to each operation a new harness was fitted into the machine, a mouse was prepared with an injection of 50 units of heparin in 100 micro-liters of bacteriostatic saline, and the mouse was restrained. Each mouse was subjected to 10 cycles in the machine. Each cycle consisted of the following operations:
The magnet was placed against the side of the SC to immobilize the magnetic antibodies.
A 1-minute wait was inserted to ensure full pelleting.
280 micro-liters of blood were withdrawn thus filling the SC.
The magnet was removed from the side of the SC. This facilitated SC mobilization during subsequent mixing operations.
An inversion stirring operation that lasted 30 seconds for the initial cycle and increased by 30 seconds with each subsequent cycle was performed.
The magnet was redeployed against the side of the SC to initiate pelleting.
Another 1-minute wait was inserted to ensure full pelleting.
The 280 micro-liters of scrubbed blood were infused into the mouse.
A 1 minute wait was inserted to allow the scrubbed blood to mix thoroughly with the rest of the mouse's blood

Afterwards, when all of the cycles were completed, the mouse was given a period for its blood to fully circulate before a blood sample was taken and sent for flow cytometric analysis. With the schedule above, a single mouse could be processed in a little over an hour.

The software considerations were cost-effectiveness and hardware integrability. The hardware considerations were similar; we had to find something that would allow our hardware to be easily controlled by whatever software we eventually chose. This narrowed our options drastically: there were few programming environments designed for inclusion of custom hardware that were also cost-effective. We chose a pair of open-source Java-like programming environments, one for the custom hardware and one for the laptop. The version running on the laptop included libraries for communication with peripherals using RS-232 and USB protocols. This satisfied our control requirements. There were ultimately three programs that worked in tandem: the preprogrammed syringe pump's factory assigned program, the custom program that accomplished the tasks of magnet positioning and inversion stirring, and the main program in the laptop that generated the cycle sequence commands output to the hardware.

### I. Results

Among our first thoughts on a method to reduce the KLRG1+/CD8+ cell burden was the direct injection of anti-KLRG1 antibodies, allowing the immune system to clear KLRG1+ cells. This method was tested in a small group of animals, and a significant reduction in KLRG1+/CD8+ cells was demonstrated (data not shown). However, this approach was abandoned over fear of body-wide ablation of other cell types that harbor the KLRG1 surface marker, notably including mast cells (where it is known as MAFA (Blaser et al., J. Immunol. 161 (12):6451-4 (1988)).

In parallel to that approach, we were developing a method to remove KLRG1+/CD8+ cells from blood ex vivo using magnetic cell sorting. Magnetic cell sorting relies on the selective tagging of cells with superparamagnetic nanoparticles, followed by their separation using a magnetic field. The technology was pioneered in the mid 1980s as an alternative to gradient centrifugation for separation of lymphocyte subsets (Lea et al., Scand J. Immunol. 22 (2):207-16 (1985)). By coating the nanoparticles with antibodies for the target cell surface marker (in our case, KLRG1), purities of >99% can be obtained.

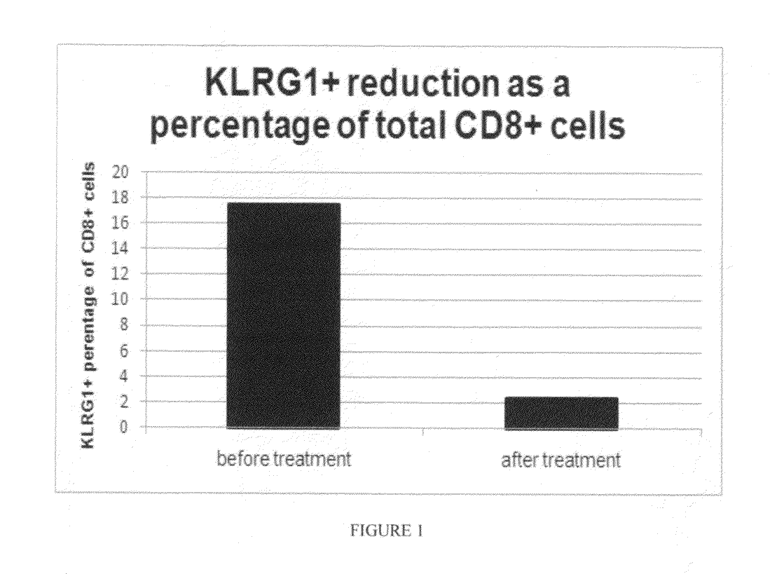

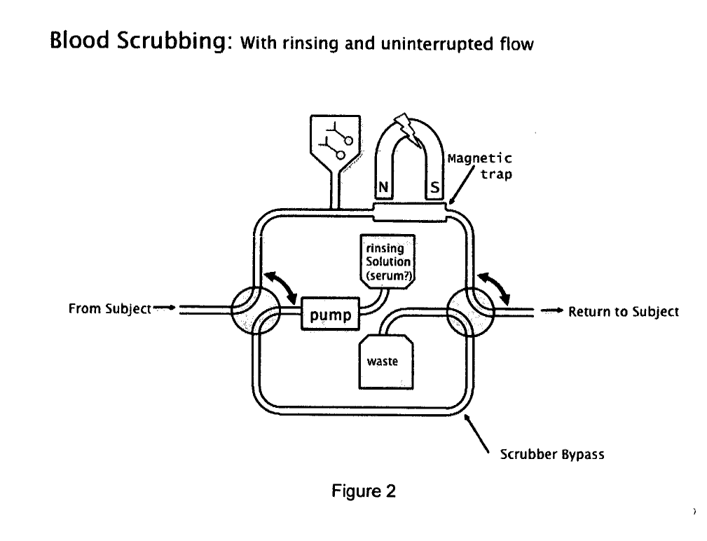

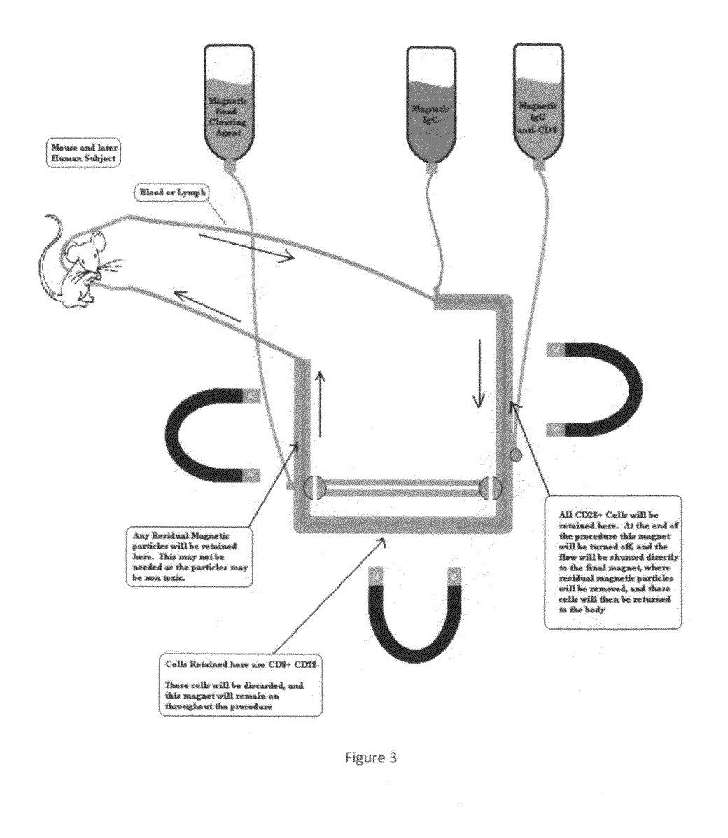

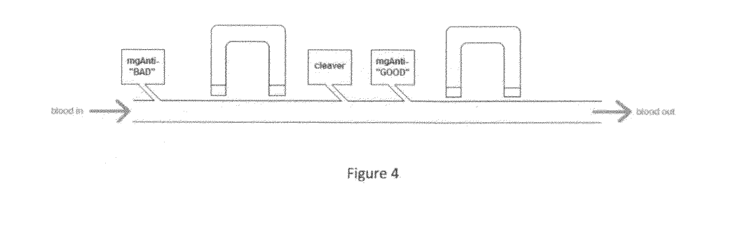

After completing a proof-of-concept trial of this approach by hand, we constructed a device (described above) that performed the procedure automatically, and used it to ablate the KLRG1+ cells from a statistically significant group of mice (n=8; FIG. 1).

### II. Discussion

KLRG1 is so named because it is found on a large fraction of natural killer (NK) cells, and is restricted there to a CD56dim subset (ibid), which is also non-proliferative but retains cytotoxic activity. It remains unclear whether CD56dim NK cells are defective, and can be safely eliminated; a functional assessment of these cells is thus urgently needed. However, we reasoned that the elimination of these cells was likely to be an acceptable side effect as, being a component of the innate immune system, they are relatively rapidly replenished.

KLRG1 is also found on CD4+ T-cells. These CD4+/KLRG1+ cells appear to be functional, both as cytokine-secreting T-helpers (virus-specific and otherwise) (Stubbe, et al., Eur J Immunol 38, 273-282 (2008)) as well as immunosuppressive T-regs (Beyersdorf, et al., Eur J Immunol 37, 3445-3454 (2007)). Of course, sparing the T-regs may be critical, as their indiscriminate destruction could result in autoimmune disease; some limited evidence for such a reaction was observed during our work with anti-KLRG1 antibodies.

Superparamagnetic iron oxide nanoparticles (SPIONs) are the most common type of magnetic nanoparticle, considered to have a low and dose-dependent toxicity (Gupta and Gupta, Biomaterials. 26 (13):1565-73 (2005)) which can be eliminated by coating with poly-(ethylene-glycol) (PEG), rendering them biocompatible at concentrations as high as 1 mg/ml (Gupta and Wells, IEEE Trans Nanobioscience 3 (1):66-73 (2004)). Although our proposed research would result in few magnetic particles entering the body, it is notable that they are already used in humans for medical and research purposes (Toso, et al., Am J Transplant 8 (3):701-6 (2008)).

The next steps in this research are to repeat our procedure over a longer period as CD8+ cells migrate out of other body compartments, and then to test the treated mice with an immune challenge to determine directly if removing these cells is functionally beneficial. Furthermore, from a basic research perspective, it would be valuable to determine how quickly the CD8+/KLRG1+ population recovers from depletion. Rapid recovery would imply a currently unappreciated significance for the suspected age-related increase in viral reactivation rates in the accumulation of these cells, in contrast to the more conventional explanation based solely on their resistance to apoptosis.

### Example 2

### Clinical Use

500 ml of patient blood are drawn using standard blood donation equipment. Then, CD8+, CD28− senescent T-lymphocytes are removed from the patient's blood by magnetic cell separation using a commercially available Miltenyi CliniMACS instrument. To do this, the CliniMACS and its consumable reagents need to be repurposed to recognize the CD8+ CD28− marker combination. The blood cells are spun down and weighed into an empty 600 ml transfer pack. The bag, a disposable tubing set and consumables are installed on the machine as per the manufacturer's instructions. 5 mg of biotinylated anti-CD28 antibody are used as the primary antibody. A standard vial of anti-biotin paramagnetic beads is used as the separation reagent. The “Enrichment” program for biotinylated antibody is executed according to the manufacturer's written and on-screen instructions. The resultant CD28+ cell fraction is retained for return to the patient. A second labeling step is carried out for CD8+ as above, using the CD28− cells prepared above as the starting material. The resultant CD8+CD28− cells are discarded. The CD8−CD28− fraction is united with the CD28+ fraction and returned to the patient. The entire procedure is repeated 5-10 times, until a dramatic reduction of the patients CD8+ CD28− cell counts has been achieved. This will allow the patient's youthful, non-anergic CD8+ CD28+ cells to expand into the immunological space opened by this procedure, resulting in an overall reversion of their cytotoxic t-cell repertoire to a more youthful state with enhanced functionality. Consequences are better response to vaccines in aging and better resilience to viral, bacterial and fungal pathogens and improved immune responses against cancer.

We claim:

1. A method of removing senescent cells substantially from a patient's body using apparatus as described herein, in order to improve immune system function in aging.

2. The method of claim 1, where the senescent cells are defined by CD8+, CD28−.

3. The method of claim 1, where the senescent cells are defined by CD8+, KLRG1+.

4. The method of claim 1, where the senescent cells are defined by CD8+, CD57+.

5. The method of claim 1, where the senescent cells are defined by KLRG1+.

6. The method of claim 1, where patient is elderly.

7. The method of claim 1, where the patient needs a vaccine in the near future.

8. The method of claim 1, where the patient is at risk of viral infection.

9. The method of claim 1, where the patient is Cytomegalovirus positive.

10. The method of claim 1, where the patient is Epstein-Barr Virus positive.

11. The method of claim 2, where the patient has >10% of all CD8+ cells positive for the respective marker.

12. The method of claim 3, where the patient has >10% of all CD8+ cells positive for the respective marker.

13. The method of claim 4, where the patient has >10% of all CD8+ cells positive for the respective marker.

14. The method of claim 1, where the apparatus is a commercially available, clinically approved magnetic cell separation machine.

15. The method of claim 14, where the apparatus is a Miltenyi CliniMACS, repurposed as described herein.

16. The method of claim 1, where the apparatus is custom-built as described herein.

17. The method of claim 1, where the patient's peripheral blood is used to access the cells.

18. The method of claim 1, where the patient's lymphatic system is used to access the cells.
